(19) United States
(12) Patent Application Publication
(10) Pub. No.: US 2005/0002558 A1
(43) Pub. Date: Jan. 6, 2005

(54) Camera based position recognition for a road vehicle

(76) Inventors: Uwe Franke, Uhingen (DE); Stefan Hahn, Ulm (DE)

Correspondence Address: Stephan A. Pendorf;Pendorf & Cutliff, 5111 Memorial Highway, Tampa, FL, 33634-7356, US

(21) Appl. No.: 10/835,130

(22) Filed: Apr. 29, 2004

(30) Foreign Application Priority Data
May 23, 2003 (DE) 103 23 915.4

(51) Int. Cl. G06K 9/00

(52) U.S. Cl. 382/154; 382/100

(57) ABSTRACT

A camera based position recognition system for a road vehicle. The environment in the direction of travel of the vehicle is acquired by a camera. Using the acquired image data, the position of the vehicle in its environment is determined with regard to an optical signature identified in the obtained image data. For determining the position of the vehicle, use is made of the knowledge of the relationship between the environment coordinate system of the optical signature and that of the camera coordinate system. In simplified manner, position determination occurs with regard to the optical signature on the basis of a template matching imposed on the image data. For this, a template or an optical signature recorded in memory is superimposed on the optical signature identified in the image data in the environment of the vehicle (template matching). From the parameters of this template matching (for example linear compression and rotation parameters) recognizing the existing coordinate system, the position of the vehicle relative to the optical signature can be directly deduced.

### BACKGROUND OF THE INVENTION

1. Field of Invention

The invention concerns a device suitable for camera based position recognition in a road vehicle and a process suited for operation of such a device according to the precharactering portion of Patent Claims 1 and 13.

2. Related Art of the Invention

In modern vehicles, in order to further increase the operating comfort of the road vehicle and to reduce the load on the vehicle operator, use has increasingly been made of autonomous or semi-autonomous functions. Thus, for example, with the aid of a system for the intelligent vehicle following the vehicle operator is assisted in maintaining spacing from the preceding vehicle, or with the aid of a camera-based traffic sign recognition system the vehicle operator is better able to concentrate, particularly in the inner city, on pedestrians and vehicles located on or near the street.

In many every-day situations it is the task of a vehicle operator to guide his vehicle along a particular path and to stop at certain locations, for example, a parking place. In order to assist a vehicle operator in such situations JP 2000-29524 A describes a line (horizontal scanning) camera based system for a track-guided vehicle. Here the vehicle is guided along by two parallel guide-lines provided on the road surface as optical signatures. The roadway below the vehicle is stepwise detected by the scanning camera perpendicular to the direction of travel. The image data acquired by the camera scan describes at respective measuring positions the existing light intensity profile perpendicular to the direction of travel. The two guidelines feature prominently in the light intensity profile, so that the system is able to guide the vehicle by centering relative to the two guide lines. This is accomplished in that the vehicle is steered transversely in the manner that the two depictions of the optical signatures (guidelines) become featured equally spaced to the center point of the light intensity profile. At those locations where the vehicle is intended to be brought to a halt, further symbolic optical signatures are provided on the roadway between the two guidelines which are also optical signatures. If the vehicle begins to travel over such symbolic optical signatures, then with each recording interval of the line camera the appearance of the light intensity profile changes depending upon the position of the vehicle in relation to the symbolic signature. The symbolic optical signature is designed in such a manner, that the light intensity profile exhibits an unambiguous and prominent pattern at that location at which the vehicle is intended to be brought to a halt. The detection of the light intensity profile by the line camera is however very susceptible to dirt on the optical signatures or frictional wearing away of the optical signatures provided on the roadway. Further, the use of guidelines for guiding a vehicle is not suited for employment in a dynamic street traffic scenario. Further yet, the optical signature is not detected until the vehicle has started to pass over it.

For a street vehicle not limited to a specific track, JP 2001-343212 A describes a camera based system for the guided entry into a parking place marked on the roadway. The system takes advantage of the fact that parking places are as a rule marked on the roadway, clearly defined on the left and right by optically recognizable lines (signatures). With image data obtained by a camera integrated in the vehicle, optical signatures (boundary lines) are identified in an image processing unit and their relative orientation is measured. Since these optical signatures are parallel straight lines, these are depicted in the camera image data as straight lines, such that the angular orientation with respect to the x- and y-axis of the camera image can be determined in simple manner. From the angular relationship of the two straight segments to each other, and knowing their spacing, it becomes possible in geometrically simple manner to calculate their distance from the vehicle and the orientation of vehicle with regard to the parking space. The image data is displayed to the vehicle operator on the camera display, wherein the display has superimposed thereupon directional arrows, which indicate how far and in which direction the vehicle must be steered in order to enter the parking space.

In accordance therewith, Japanese Patent Applications JP 2002-172988 A and JP 2002-172989 A describe the possibility of using the image recognition system known from JP 2001-343212 A and, based thereon, providing an at least semi-autonomous vehicle guidance for entering into a parking space, wherein the vehicle track necessary for parking is calculated in advance. The evaluation of the image data for positional recognition however has the necessary precondition of clearly visible optical signatures (boundary lines), such that their angular features can be determined from the image data. In particular it is necessary for a correct positional recognition that the starting point of the optical signatures on the vehicle lane can be clearly recognized. In reality, this is however not always possible due to dirt on, or friction wear away of, the line marking. Further, for driving into the parking space, an automatic positional calculation is no longer possible as of the point in time at which the beginning of the optical signatures can no longer be acquired by the camera, at least not without additional sensory aids.

### SUMMARY OF THE INVENTION

It is thus the task of the invention to find a camera based position recognition system for road vehicles, which on the one hand permits a free maneuverability of the vehicle and on the other hand is robust with respect to obstruction of, or as the case may be, dirt coverage or frictional wear of, the optical signatures to be recognized.

The task is solved by a device and a process for camera based position recognition for a road vehicle with the characteristics of Patent Claims 1 and 13.

Advantageous embodiments and further developments of the invention can be seen from the dependent claims.

In the novel camera based position recognition system for a road vehicle, the environment in the direction of travel of the vehicle is acquired by a camera. Using the acquired image data, the position of the vehicle in its environment is determined with regard to an optical signature identified in the obtained image data. For determining the position, use is made of the knowledge of the relationship between the environment coordinate system of the optical signature and that of the camera coordinate system. In simplified manner, the position determination occurs with regard to the optical signature on the basis of a template matching imposed on the image data. For this, a template or an optical signature recorded in memory is superimposed on the optical signature identified in the image data in the environment of the vehicle (template matching). From the parameters of this template matching (for example linear compression and rotation parameters) recognizing the existing coordinate system, the position of the vehicle relative to the optical signatures can be directly deduced. By applying template matching to the problem addressed by the present invention, advantage is taken of the fact that this process works also with high reliability even in the case that the optical signature in the image data is not completely recognizable due to coverage (for example by obscuring with the own vehicle while driving over, or also temporary blocking by other traffic participants). Template matching also performs particularly robustly in those cases in which the optical signature is not depicted optimally in the image data due to coverage with dirt or due to being worn away.

### BRIEF DESCRIPTION OF THE DRAWINGS

In the following the invention will be described in greater detail on the basis of an illustrated embodiment and figures. Therein there is shown

FIG. 1 two typical road markings in the area of a bus stop and

FIG. 2 templates, which are extracted from the images of the vehicle lane markings displayed in FIG. 1.

FIG. 3 describes the geometric relationships underlying the calculations,

FIG. 4 shows an example of the projection of a three dimensional template upon a plane (roadway) comprised of a list of points,

FIG. 5 illustrates the effect of the variation of the orientation parameters of the camera on the superimposing of templates and image data,

FIG. 6 illustrates an example of a two-dimensional perspective image,

FIG. 7 shows the perspective image of the image data represented in FIG. 1a),

FIG. 8 describes the sequence in the framework of detection as a flow diagram,

FIG. 9 shows the result of Powell minimization over a sequence of images,

FIG. 10 shows a template superimposed over the image data with a rectangle circumscribing the template for tracing using Kalman filtering,

FIG. 11 shows the optimization of the Powell minimization by means of the Kalman filter,

FIG. 12 shows a flow diagram describing the matching and tracking process,

FIG. 13 shows the robustness of the process on the basis of various camera orientations with regard to an identical position marking.

### DETAILED DESCRIPTION OF THE INVENTION

In particularly preferred manner, an at least semi-autonomous vehicle guidance is initiated based upon the knowledge or acquisition of the position of the vehicle with regard to the optical signature. In the framework of this vehicle guidance, the vehicle is brought to a halt, for example at a predetermined position relative to the optical signature. It is also conceivable, beginning at a position defined in relation to the optical signature, for example in the case of directional arrows on the roadway, to orient the vehicle in a defined manner on the roadway, or, in the case of the recognition of a stop line associated with a traffic signal, to bring the vehicle to a halt using an ideal braking sequence in the case of red traffic signal.

In particularly useful manner the invention can be designed such that template matching occurs in a three dimensional coordinate space. Thereby it becomes possible not to limit the optical signatures, on the basis of which the position of the road vehicle is to be computed, to two dimensional optical signatures on the roadway. Accordingly it becomes possible to use already present three dimensional objects as optical signatures for camera based position recognition. Further, it becomes possible to place suitable two dimensional optical signatures in spatial locations other than on the roadway or road surface. In this manner the optical signatures can be placed at locations which are better and which in particular can be protected against dirt and wear; it would be conceivable, for example, for the autonomous navigation of a vehicle in a garage, to place the optical signatures on the inside front wall of the garage. It would also be conceivable in the case of a convoy to derive a three dimensional template from the image data of the preceding vehicle, so that a vehicle, with the aid of the present invention, can follow the preceding vehicle with defined spacing and alignment.

In particular in the case of optical signatures which are subjected to weather influences, their image characteristics in the camera image are strongly dependent upon the actual weather conditions (dry or wet). It has been found that the reliability of the template matching can be increased in particular in the case when the superimposing of camera image data and template is carried out on the basis of edge or border images (both camera image data as well as templates). In this case the camera image data must be subjected to an edge extraction prior to template matching.

Further, the robustness of the template matching can also be improved thereby, that the template of the optical signal is recorded and processed not as an edge image but rather on the basis of individual points, that is, as a list of points. Thereby it becomes possible to robustly process also image data within which the contours of the optical signature appear only interrupted or with a poor contrast, using template matching. One such representation of the template also makes it possible to reconstruct these during the construction thereof in the learning phase of the system directly from image data recorded as examples. For this it is merely necessary, from the image data generated by the camera system, by reverse calculating, for individual coordinate systems of individual image data of the optical signature, to directly assign a point within the point list of the template. Poorly depicted optical signatures in the image data can therewith be usefully recorded in the framework of a point list as template, so that the point list can possibly be improved or, as the case may be, corrected by further image data.

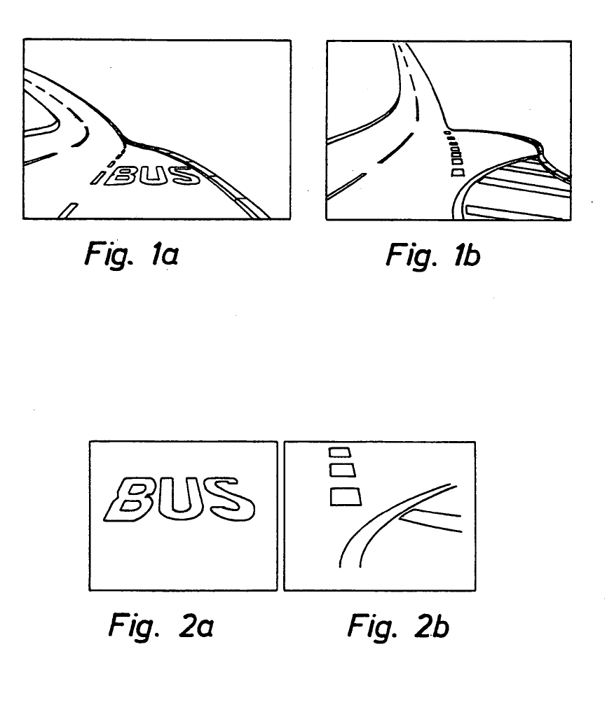

In the following the invention will be described in greater detail by way of example on the basis of the use for the systematic guidance of the approach of busses to bus stops. A precise positional estimation is very necessary for this, in order on the one hand to prevent damage in particular to vehicle tires and on the other hand to increase the riding comfort of the bus occupants, in that the bus stop is approached with a vehicle track and a braking process which is ideal therefore. Therein, the inventive system for camera based position estimation for a road vehicle is so designed, that it autonomously carries out the approach guidance of passenger busses to their bus stops. Therein the position of the bus is continuously estimated with regard to the coordinate system of the vehicle environment (world coordinate system) in which the optical signatures of the street markings, stop lines or other patterns typical for bus stops are located. The position recognition occurs herein on the basis of the image data of a camera, which detects or acquires the environment of the passenger bus, wherein the image data is compared (matching) with a model (template) of the bus stop. Positional estimation is not simple in particular for the reason that the typical markings at bus stops are conventionally not comprised of straight lines. FIG. 1 shows two typical lane markings as they are found in the area of a bus stop. FIG. 1a) shows the optical signature the word “BUS”, which is most commonly applied to the road surface in the area of the location of the bus stop, at which the bus is intended to come to a stop. FIG. 1b) shows the image data of a typical entryway into a bus stop. Therein a curved line is to be seen in the right foreground as optical signature, which leads from the general roadway to the roadway reserved for busses in the area of the bus stop. The boundary between this roadway and the general roadway, as can be seen in the lower central area of the image, is comprised of an optical signature in the form of a relatively broad, interrupted straight line or, as the case may be, line elements. It can be seen from FIG. 1 that it is advantageous, during position estimation at bus stops, when the system for camera based position estimation is capable, depending upon the position of the passenger bus, to selectively choose one of multiple various templates stored in memory. In FIGS. 2a) and b) the two templates corresponding to the two optical signatures typically found in the area of bus stops (see FIG. 1) are depicted or mapped.

Since in the area of the bus stop various optical signatures must be taken into consideration (1a) or 1b)) depending upon the position of the passenger bus, it is particularly advantageous when, in the device for the camera based positional estimation, the means for the specific selection of one of multiple templates is in communication with a navigation system, which has access to a GPS or a map information system. In this manner it can already be predicted, preliminary to template matching, which of the optical signatures is to be found in the camera acquired image data of the vehicle environment. If such modern navigation or map information is however not available, then it is likewise also possible to carry out template matching attempts with the various templates available until one of the templates can be fitted or matched to a corresponding optical signature. Such a sequential selection process can advantageously also be shortened by taking advantage of previous knowledge; thus it is clear, that once the bus stop entranceway (according to FIG. 1b)) has been passed, then soon thereafter image data of the “BUS” signature (according to FIG. 1a)) should occur.

In place of the use of artificially produced templates (for example CAD-models), it is particularly advantageous to produce the templates directly from real live image data in the system for camera based position recognition. For this it is necessary, with knowledge of the relationship of the camera coordinate system to the world coordinate system (coordinate system of the vehicle environment) existing in the recorded image, to trace or calculate back the individual image points within the image data to individual points within the point list of the template. There is the possibility therein of a manual processing of the image data, wherein the image data representing the optical signature are selected manually. On the other hand, it is likewise also conceivable, in particular when sufficient computer power is available, to automatically select suitable optical signatures from the image data and to translate these into a template “online”, that is, during the actual operation of the system (for example, as the depiction of a preceding vehicle to be followed).

The production of the template from the real world image data occurs in the well known procedure known to those persons of ordinary skill in this art by reverse transformation (R. C. Gonzales, R. E. Woods, Digital Image Processing, Addision Wesley Publ. Company, 1992).

For explaining reverse transformation, in the following examples of the necessary equations are provided in simplified form based on the assumption that the optical signature is in an x-z-plane and does not extend into the y-plane (y=0):

$${Z}_{w} = \frac{\begin{matrix}- h \{ ( {X}_{i} - {x}_{ic} ) \frac{f}{{S}_{x}} \cdot sin φ + \\ ( {Y}_{i} - {y}_{ic} ) \frac{f}{{S}_{y}} cos φ sin α - f cos φ cos α \}\end{matrix}}{( {Y}_{i} - {y}_{ic} ) \frac{f}{{S}_{y}} cos α + f sin α}$$

$${X}_{w} = \frac{\begin{matrix}h \{ ( {X}_{i} - {x}_{ic} ) \frac{f}{{S}_{x}} cos φ - \\ ( {Y}_{i} - {y}_{ic} ) \frac{f}{{S}_{y}} sin φ sin α + f sin φ cos α \}\end{matrix}}{( {Y}_{i} - {y}_{ic} ) \frac{f}{{S}_{y}} cos α + f sin α}$$

$${Y}_{w} = 0.0 ;$$

wherein w refers to the world coordinate system, i to the camera coordinate system and ic to the center point of the camera coordinate system. f corresponds to the focal width of the camera, Sₓ refers to the horizontal pixel size and S_{y} to the vertical pixel size of the camera chip. h represents the height of the camera, φ represents the angle of yaw and α represents the angle of pitch of the camera.

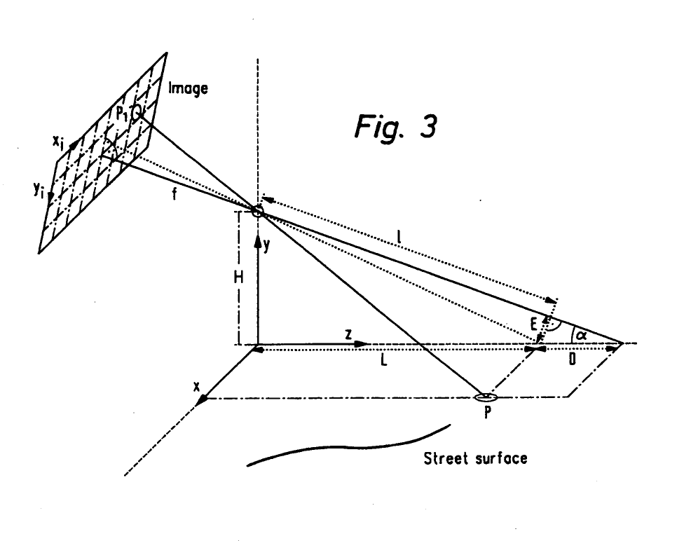

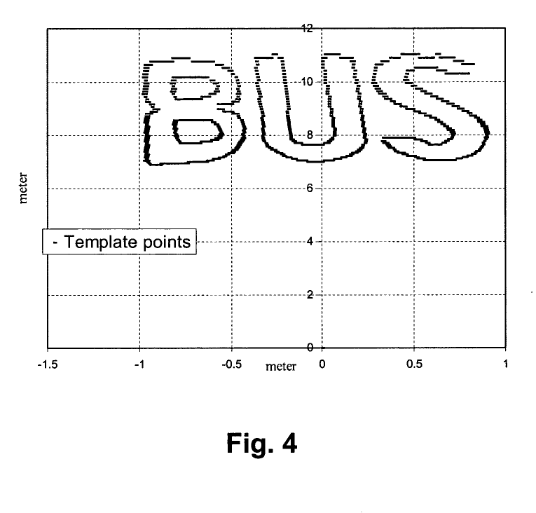

FIG. 3 describes the basic geometric relationships underlying the equations. In practice, in passenger busses one can assume, due to their broad wheel stance, that there is a constant angle of pitch α and a constant height h. The angle of roll and the angle of yaw φ can be presumed to be zero. In FIG. 4 there is depicted a three dimensional template obtained by such a back transformation of image data (corresponding to FIG. 1a)).

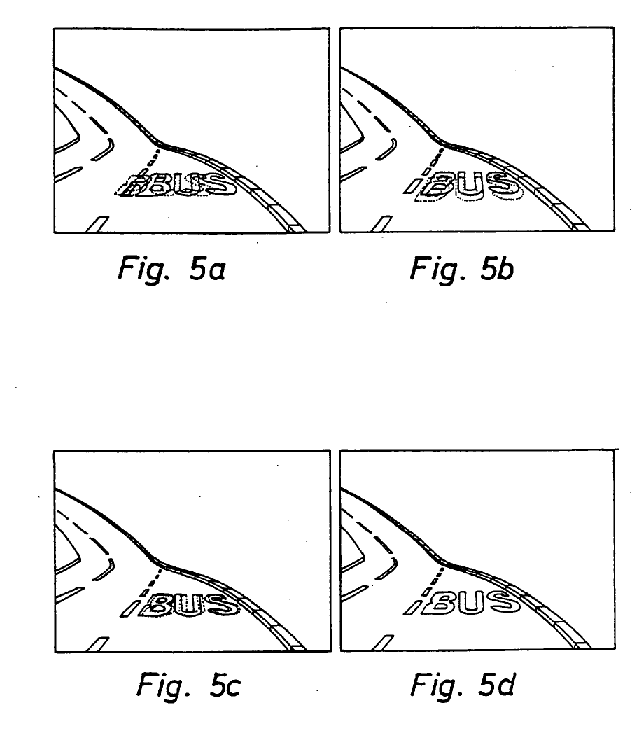

In the framework of template matching, the camera coordinates are calculated from the relationship between the image or mapping or transformation parameters of the image data of the template adapted to the optical signature and the coordinates of the vehicle environment. For this, a computer is used to stepwise change the orientation of the camera, and to compare the quality of the correspondency of the depiction of the template with the image data of the optical signature for each change. In FIGS. 5a)-d) such a variation process is shown for illustrative purposes. The known template from FIG. 4 has superimposed upon it multiple times, under the assumption of different camera coordinates, the image data from FIG. 1a), and with the camera coordinates assumed for FIG. 5d) an optical superimposition was obtained (“best fit”). In relationship to the camera coordinates assumed for FIG. 5d) FIG. 5a) represents a displacement of the camera by 0.5 m in the x-direction, FIG. 5b) represents a displacement by 0.5 m in the y-direction and FIG. 5c) represents an offset of the pitch angle b of 1°. It can be seen that even in the case of small variations of the assumed camera coordinates a significant mismatch (lack of correspondency between image data and thereupon projected template) occurs. On the other hand, this is a sign, that in the case of good agreement (match) the camera coordinates should also be very well estimated.

Following the transformation from the world coordinate system (coordinate system of the environment or as the case may be the optical signature) in the camera coordinate system by transformation and rotation, the projection for the superimposition shown in FIG. 5 was simplified thereby, according to

$${X}_{im} = \frac{f}{{S}_{x}} \cdot \frac{{X}_{c}}{{Z}_{c}} + {mx}_{0}$$

$${Y}_{im} = - \frac{f}{{S}_{y}} \cdot \frac{{Y}_{c}}{{Z}_{c}} + {my}_{0}$$

For determining the best fit of template and image data, it is within the contemplation of the invention in advantageous manner to achieve the wellness of the correspondence or fit in the framework of a standard correlation according to

$$c ( s , t ) = {\sum }_{x} {\sum }_{y} f ( x , y ) w ( x + s , y + t )$$

Therein the summation occurs over that area, for which the depiction of the template w(x,y) and the image data of the optical signature f(x,y) overlap. For this, then, the maximal value of c(s,t) occurs when the correspondence of the depiction of the template exhibits the highest correspondence with the image data of the optical signature. One such method of calculation has been found particularly useful in particular for processing of gray scale images. If, however, edge images are processed, then this calculation method is not particularly robust for the “best fit”. A “best fit” can therein only be found, when the template precisely corresponds in size an orientation with the segment of the edge image representing the optical signature.

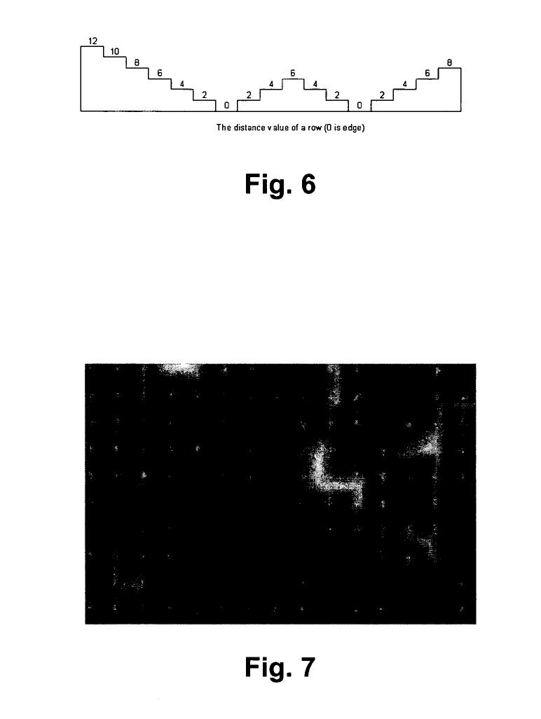

For this reason one could consider, in the case of processing of edge images, to subject the edge images prior to template matching or, as the case may be, the search for the “best fit”, first to a distance transformation (R. Lotufo, R. Zampirolli, Fast multidimensional parallel Euclidean distance transform based on mathematical morphology, in T. Wu and D. Borges, editors, Procceedings of SIBGRAPI 2001, XIV Brazilian Symposium on Computer Graphics and Image Processing, pages 100-105. IEEE Computer Society, 2001). The image resulting from the distance transformation is an image, in which each value of an image point describes the distance of this image point to the edge lying nearest thereto. The image points of one edge are therein charged with a value 0, while the farthest point is allocated a predetermined maximal value. In FIG. 6 an example for the value distribution within a two dimensional perspective or distance image (line) is illustrated. In the generational of a distance image, essentially three processing steps are to be followed. First, an edge image is produced from the image data provided by the camera. Then, for each of the image points, the distance to the nearest lying edge is determined (image points of the edge are assigned the value 0). Finally, all image points are assigned the above determined values in place of the original image information. In FIG. 7 there is shown an example of a distance image as gray value calculated from the image data shown in FIG. 1a). The lighter the image points in this perspective or distance image, the further this image point is from an edge.

If then in advantageous manner the template matching occurs on the perspective or distance image, then preferably the standard correlation of the perspective or distance transformed image to the depiction of the template is calculated according to

$$DS = {\sum }_{i = 1}^{n} {D}_{im} ( T [ template ] ) = f ( α , β , φ , X , Y , Z )$$

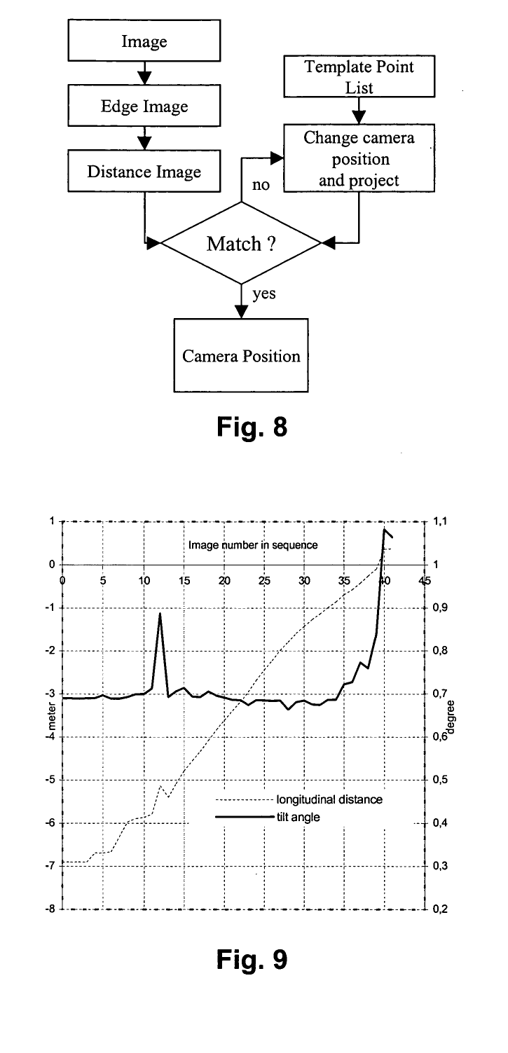

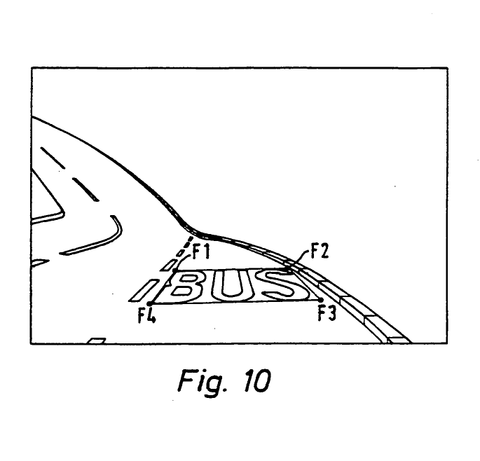

Therein α, β, φ, X, Y, Z describe pitch, roll and yaw angle of the vehicle, as well as the camera pose in longitudinal, lateral orientation and in its height. T describes the transformation of the coordinate system of the environment into the camera coordinates and Dᵢₘ the value of the distance transformation of those image data, which correspond with the corresponding point of the template. The value DS is minimal in the case, which indicates the correspondency of the depiction of the template with the image data of the optical signature with the highest correspondency (“best fit”). In FIG. 8 the above described preferred process for template matching is again described in the form of a flow diagram. The camera coordinates and therewith the position of the road vehicle can particularly effectively be determined by means of two sequential process steps. In a first step the depiction parameters of the template are varied in large steps, so that relatively quickly a first rough estimation can be determined. This process step can further be accelerated when the height of the camera and the tilt angle are not taken into consideration or are not varied. In particular when the invention is employed in dynamically lethargic vehicles such as passenger busses, the pitch angle can also be omitted from the variables.

In a refined search step subsequent to the rough search step, the value range is more narrowly limited about the previously roughly determined estimated value. Therein, in preferred manner, in iterative steps, the step-width of the parameter variation can be stepwise be reduced. It has been found in practice that, by means of this two-step process, good result can already be achieved after 2-3 iteration steps.

Such a result can further improved when thereafter in preferred manner the Powell minimization algorithm is employed (S. A. Teukolsky, B. P. Flannery, W. H. Press, W. T. Vetterling, Numerical Recipes in C++. The art of Scientific Computing, Chapter 10, Second Edition). This algorithm seeks to determined the minimum of a function, requires therefore however no derivation of this function, but rather is satisfied with good start coordinates. The basic idea behind the Powell minimization is comprised therein that the search for the minimum in three dimensional space is subdivided into multiple searches for minimum in two dimensional space. This algorithm begins with a set of vectors; generally unit vectors. The minimization method runs, beginning from the start point, along one of these vectors until it hits upon a minimum. From there it runs in the direction of the next vector until again a minimum occurs. This process is continued so long, until certain predetermined conditions, such as for example the number of iterations or minimal changes to be achieved, are satisfied. The meaning or significance of Powell minimization is to be seen in its automatism in the minimum search. In the employment of the Powell minimization in the framework of the inventive camera based position determination, the optimized camera coordinates, as they were found in the rough incremental search (as described above), serve as starting point. Since the camera coordinates in general only change insignificantly from image to image, there is for the processing of an image sequence, the last Powell minimization is always employed as the optimal determined camera coordinate as the starting point of a new Powell minimization. This manner of proceeding saves extensive rough and fine computer incremental searches for each individual image. For a better understanding of the effect of the Powell minimization, reference may be made to FIG. 9. In FIG. 9 the result of a Powell minimization is shown with regard to an image sequence, as they typically occur for the illustrative example of the invention for camera based position estimation in passenger busses in the vicinity of bus stops. Over an image sequence of 41 images the estimated (longitudinal) distance of the passenger bus to the optical signature (broken line) and the pitch angle of the passenger bus (solid line) are shown. The diagram shows, for the 12th image within the image sequence, an unexpected value for the longitudinal distance. However, in view of the curve representing the pitch angle, here a jump is to be seen, so that it becomes clear that during the processing of these image data an estimation error must have occurred. Therewith it can be seen that it is particularly advantageous to observe or follow the estimated camera coordinates over time and to place them in relation to each other, since an error in the estimation of the longitudinal distance and the pitch angle is difficult to recognize from only one single monocular image.

In particularly preferred manner, during the continuous observation of image sequences, the result or product of the Powell minimization can be be further improved when the results of the individual Powell minimizations are subjected to a Kalman filter (G. Welch, G. Bishop, An Introduction to the Kalman Filter, University of North Carolina at Chapel Hill, Department of Computer Science, TR 95-041). In a design of the Kalman filter particularly suitable for the inventive camera based position estimation, five degrees of freedom of the total system are taken into consideration. These are the longitudinal distance (Z), the speed (V), the yaw angle (φ), the pitch angle (α) and the sideways displacement (X). Taking into consideration these degrees of freedom, the following filter model results:
V=\dot{Z}=Vᵥₑₕ
\dot{V}=0
\dot{φ}=\dot{φ}_{vehicle}
\dot{α}=0
\dot{X}=Vφ

In the following the equations necessary for calculation are provided. Due to the perspective projection at hand, the equations are non-linear. Accordingly, in the inventive embodiment the augmented form of the Kalman filter and the Jakobi matrix form of the equation system must be employed.

$$xi = \frac{f \cdot \frac{Xc}{Zc}}{Sx} + mx0$$

$$yi = \frac{- f \cdot \frac{Yc}{Zc}}{Sy} + my0$$

Wherein Xc, Yc and Zc are the coordinates Xw, Yx and Zw of the optical signature (world coordinate system) transformed into the camera coordinate system; according to:
Xc=Xw cos φ cos β+(Yw−h)cos φ. sin β−Zw sin φ
Yc=Xw(sin α sin φ cos β−cos α sin β)+(Yw−h)(sin α sin φ sin β+cos α cos β)+Zw sin α cos φ
Zc=Xw(cos α sin φ sin β+sin α sin β)+(Yw−h)(cos α sin φ sin β−sin α cos β)+Zw cos α cos φ

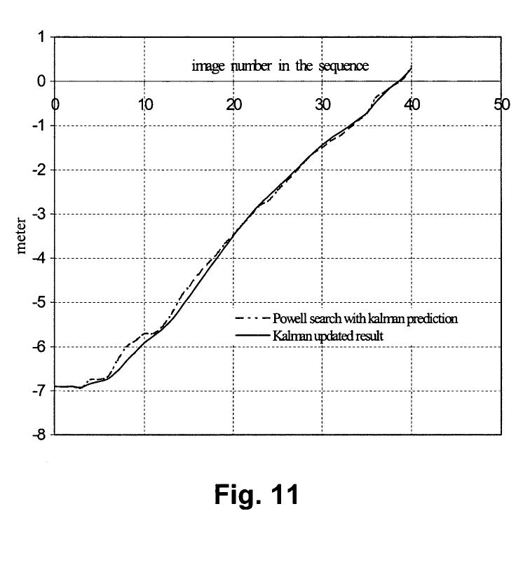

In FIG. 11 there is provided for comparison the longitudinal distance (dashed line) determined by means of the Powell minimization and its improved estimation by means of the above Kalman filtering (solid line). The Kalman filtering results in a very soft or steady transition in the longitudinal distance, which also most closely approximates the real preference of bus occupants. It is also noteworthy that the error in image 12, which was clearly pronounced in the curve in FIG. 9, no longer appears. On the other hand, despite the identical image material, it also no longer occurs in the new calculation using the Powell minimization (dashed line); this effect can be traced thereto, that in this pass, in the estimation by means of the Powell minimization, the starting point was different.

Alternatively to the use of the Powell minimization algorithm, it is very easy to also envision in the cases in which good estimations are present, that the parameters of the corresponding image points between model and edge image are directly supplied to the Kalman filter. For this, a Kalman filter is particularly suitable in the design and parameterizing as described above in connection with Powell minimization.

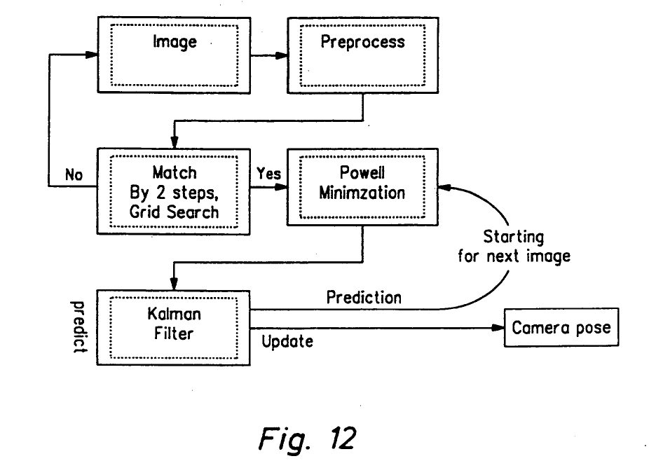

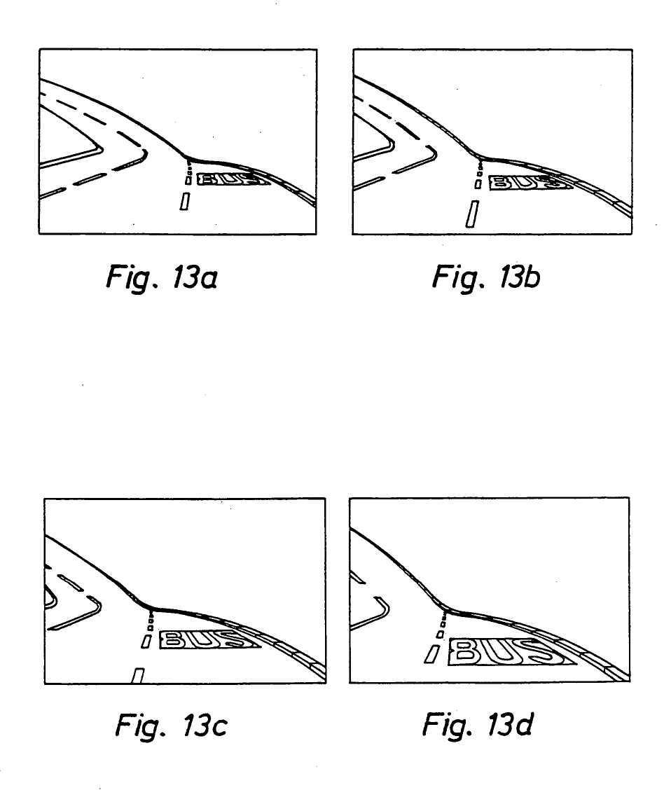

In concluding the preceding detailed discussion is represented in condensed form in FIG. 12, showing the entire template matching and tracking as a flow diagram. FIG. 13 shows examples of the use of this process. Herein the template represented in FIG. 2a) was sequentially superimposed on a sequence of image data detected during the driving into the bus stop. Although during the sequence of these four exemplary image data the longitudinal distance between camera and optical signature respectively changed by more than 2 meters, the result of the template matching showed faultless superimposition during the entire process of the driving up to the bus stop; in the reverse, thus, the position of the passenger bus was able to be estimated with very good precision from the image parameters.

Of course the invention is not limited specifically to the driving up of busses to bus stops, but rather can in particular also advantageously be employed for assisting during parking in parking spaces, garages or other vehicle rest areas. In one such advantageous embodiment of the invention suitable parking spaces can be provided with appropriate optical signatures. For this, the optical signatures need not necessarily be applied to the road surface or, as the case may be, the floor of the parking space or garage, but rather it is also very conceivable to provide suitable optical signatures in certain cases on the wall of the parking space (wall in a parking garage). Since the invention in advantageous manner also opens the possibility of using three dimensional optical signatures, of which the image data are to be compared with three dimensional image data (matching), it is also conceivable not to provide specialized optical signatures, but rather to utilize therefor already existing suitable structural features.

1-23. (Cancelled)

24. A process for camera-based position recognition for a road vehicle, comprising:
obtaining image data of the environment in the direction of travel of the vehicle using a camera,
determining the position of the vehicle in its environment relative to an optical signature identified in the obtained image data on the basis of template matching imposed on the image data, and on the basis of knowledge of the relationship between the environment coordinate system and the camera coordinate system.

25. A process according to claim 24, further comprising initiating an at least semi-autonomous vehicle guidance upon determining the position of the vehicle relative to the optical signature, during which the vehicle is brought to a halt at a predetermined position relative to the optical signature.

26. A process according to claim 24, wherein the template matching occurs in a three dimensional coordinate space.

27. A process according to claim 24, wherein the template matching occurs on the basis of an edge image.

28. A process according to claim 24, wherein the template is stored as a list of points, and wherein the template matching occurs on a point-to-point basis.

29. A process according to claim 24, further comprising selecting a template from a number of different templates prior to the matching of the template with the image data.

30. A process according to claim 29, wherein the selection occurs on the basis of GPS or map information.

31. A process according to claim 24, comprising, in the framework of the template matching, in which the camera coordinates are calculated on the basis of the relationship between the image parameters of the template matched to the image data of the optical signature and the coordinates of the vehicle environment,
computationally stepwise changing the orientation of the camera, and
comparing, for each change, the quality of the correspondence or fit of the depiction of the template with the image data of the optical signature.

32. A process according to claim 31, wherein for calculation of the quality of the correspondence a standard correlation is calculated according to
$$c ( s , t ) = {\sum }_{x} {\sum }_{y} f ( x , y ) w ( x + s , y + t )$$
wherein the summation occurs over those ranges, for which the depiction of the template w(x,y) and the image data of the optical signature f(x,y) overlap, and
wherein the maximal value of c(s,t) then occurs, when the correspondence of the depiction of the template has the best fit with the image data of the optical signature.

33. A process according to claim 31, comprising
subjecting the image data to a distance transformation prior to the computation of the standard correlation, and
subsequently calculating the standard correlation of the distance transformed image with the depiction of the template according to
$$DS = {\sum }_{i = 1}^{n} {D}_{im} ( T [ template ] ) = f ( α , β , φ , X , Y , Z )$$
wherein α, β, φ, X, Y, Z represent the pitch, tilt and roll angles of the vehicle, as well as the camera pose in the longitudinal, lateral orientation and in its height, T describes the transformation of the coordinate system of the environment into the camera coordinates and Dₘ represents the value the distance transformation of those image data, which correspond with the appropriate points in the template, and wherein DS then is minimal, when the correspondence of the depiction of the template exhibits the highest wellness of fit with the image data of the optical signature.

34. A process according to claim 33, further comprising making use of Powell minimization for determining the actual minimum DS.

35. A process according to claim 33, further comprising improving the estimation of the actual minimum by the subsequent use of a Kalman Filter.

36. A device for camera based position recognition for a road vehicle, comprising:
a camera for detecting the environment in the direction of travel of the vehicle, and
an image processing unit with object recognition for determining the position of the vehicle with regard to an optical signature in the environment of the vehicle,
a memory unit in which a template is stored corresponding to the optical signature, the memory unit in communication with the image processing unit for position determination, and
a means for template matching accessible to the image processing unit, via which means the template can be superimposed over the image data stored in the memory.

37. The device according to claim 36, wherein the template stored in the memory unit is a three dimensional template.

38. The device according to claim 36, wherein the template substantially corresponds to the edge image of the optical signature.

39. The device according to claim 36, wherein the template is organized as a list of points, such that the template matching occurs on a point-to-point basis.

40. The device according to claim 36, wherein the templates of a number of various optical signatures are stored in the memory unit, which can be selected from for template matching.

41. The device according to claim 40, wherein the device is in communication with a unit for position determination, in particular a GPS system or a map navigation system, via which the selection of the templates for template matching is controlled.

42. The device according to claim 36, wherein the image processing unit includes means via which the image data obtained by the camera can be subjected to a distance transformation, and means via which the standard correlation of the distance transformed image with the depiction of the template of the optical signature is calculated according to
$$DS = {\sum }_{i = 1}^{n} {D}_{im} ( T [ template ] ) = f ( α , β , φ , X , Y , Z )$$

43. The device according to claim 42, wherein the image processing unit includes a device for Powell minimization for determining the actual minimum DS.

44. The device according to claim 42, wherein the image processing unit includes a Kalman Filter adapted to further improve the estimation of the actual minimum.

45. A process according to claim 24, wherein said position recognition and/or a step of destination guidance is carried out in road vehicles in the vicinity of bus stops.

46. A process according to claim 24, wherein said position recognition and/or a step of destination guidance is carried out in road vehicles in the vicinity of parking spaces or parking lots or parking garages.
